(19) United States
(12) Patent Application Publication
(10) Pub. No.: US 2009/0017343 A1
(43) Pub. Date: Jan. 15, 2009

(54) FUEL CELL SYSTEM HAVING PHOSPHORIC ACID POLYMER ELECTROLYTE MEMBRANE AND METHOD OF STARTING THE SAME

(75) Inventors: TAE-WON SONG, Yongin-si (KR); Akira Suzuki, Seongnam-si (KR); Dong-kwan Kim, Suwon-si (KR); Hyun-chul Lee, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/942,874

(22) Filed: Nov. 20, 2007

(30) Foreign Application Priority Data
Jul. 12, 2007 (KR) 2007-70075

(51) Int. Cl. H01M 8/02

(52) U.S. Cl. 429/13; 429/26

(57) ABSTRACT

A method of starting a fuel cell system and a fuel cell system including: a fuel cell stack having a phosphoric acid polymer electrolyte membrane, in which an electrochemical reaction occurs using hydrogen and oxygen; a cooling water circulating unit that supplies heated cooling water to the stack to increase the temperature of the stack; and an air circulating unit that provides heated air, as a source of the oxygen, to the stack. The circulating unit can include a heating unit to directly heat the air and/or a heat exchanger to heat the air using air exhausted from the stack. The temperature of the stack can be rapidly increased by supplying the heated air and by generating an endothermic reaction in the stack. The condensation of water vapor in the stack is repressed while the stack is heated, by the heating of the air and/or by increasing the pressure of the air.

### CROSS-REFERENCE TO RELATED APPLICATION

This application claims the benefit of Korean Application No. 2007-70075, filed Jul. 12, 2007, in the Korean Intellectual Property Office, the disclosure of which is incorporated herein by reference.

### BACKGROUND OF THE INVENTION

1. Field of the Invention

Aspects of the present invention relate to a fuel cell system that can rapidly increase the temperature of a fuel cell stack having a phosphoric acid polymer electrolyte membrane, during start up, and a method of starting the fuel cell system.

2. Description of the Related Art

A fuel cell is an electric generator that changes chemical energy of a fuel into electrical energy, through a chemical reaction, so long as the fuel is supplied. FIG. 1 is a schematic drawing illustrating the energy transformation structure of a conventional fuel cell 10. Referring to FIG. 1, when air, which contains oxygen, is supplied to a cathode 1, and a fuel, which contains hydrogen, is supplied to an anode 3, electricity is generated by reverse water electrolysis through an electrolyte membrane 2. The membrane 2 is a polymer electrolyte membrane that contains phosphoric acid, and is configured to operate at a high temperature of approximately 120° C., or more.

The electricity generated by one fuel cell 10 (unit cell) does not produce a useful high voltage. Therefore, electricity is generated by a fuel cell stack 100, in which a plurality of unit cells 10 are connected in series, as depicted in FIG. 2. As depicted in FIG. 3, flow channels, including surface flow channels 4a of a bipolar plate 4, supply hydrogen or oxygen to the anode and cathode electrodes 1 and 3 of each of the unit cells 10. Accordingly, when hydrogen and oxygen are supplied to the stack 100, as depicted in FIG. 2, the hydrogen and oxygen are supplied to the corresponding electrodes 1 and 3, and are circulated through the flow channels of each of the unit cells 10.

During the electrochemical reaction, electricity and heat are generated. Therefore, for a smooth operation of a fuel cell, the fuel cell stack 100 must be continuously cooled to dissipate the heat. Thus, in the fuel cell stack 100, a cooling plate 5, to channel cooling water for heat exchange, is mounted on every 5th or 6th unit cell 10. Accordingly, the cooling water absorbs heat in the stack 100, while passing through flow channels 5a of the cooling plate 5. The cooling water is cooled in the heat exchanger H5 (refer to FIG. 4), by secondary cooling water, and is circulated back to the stack 100.

A hydrocarbon containing fuel source, such as natural gas, is used to produce hydrogen for the fuel cell stack 100. Hydrogen is produced from the fuel source in a fuel processor 200, as depicted in FIG. 4, and is supplied to a stack 100.

The fuel processor 200 includes a desulfurizer 210, a reformer 220, a burner 230, a water supply pump 260, first and second heat exchangers H1 and H2, and a carbon monoxide (CO) removing unit 250. The CO removing unit includes a CO shift reactor 251 and a CO remover 252. A hydrogen generation process is performed in the reformer 220. That is, hydrogen is generated in the reformer 220 using the burner 230, through a chemical reaction between the hydrocarbon containing fuel source (entering from a fuel tank 270) and steam (supplied from a water tank 280 by the water supply pump 260). CO₂ and CO are generated as byproducts.

If a fuel containing 10 ppm, or more, of CO is supplied to the stack 100, the electrodes 1 and 3 are poisoned, resulting in a rapid reduction of the performance of the fuel cells 10. Therefore, the content of CO in the fuel, at an outlet of the reformer 220, is controlled to be 10 ppm, or less, by installing the CO shift reactor 251 and the CO remover 252. A chemical reaction to generate CO₂, by reacting CO with steam, occurs in the CO shift reactor 251. An oxidation reaction between CO and oxygen occurs in the CO remover 252. The CO content in the fuel that has passed through the CO shift reactor 251 is 5,000 ppm, or less, and the CO content in the fuel that has passed through the CO remover 252 is reduced to 10 ppm, or less. The desulfurizer 210 is located at an inlet of the reformer 220, and removes sulfur components contained in the fuel source. The sulfur components are absorbed while passing through the desulfurizer 210, because the sulfur components can easily poison the electrodes at concentrations as low as 10 parts per billion (ppb).

When a fuel cell system having the fuel processor 200 and the stack 100 is operated, hydrogen is generated in the fuel processor 200 through the process described above, and an electrochemical reaction occurs in the stack 100, using the hydrogen supplied from the fuel processor 200, as a fuel. In FIG. 4, a simplified stack 100 is depicted. However, as described with reference to FIG. 3, hydrogen passes through corresponding flow channels to the anode electrodes 1, and air passes through corresponding flow channels to the cathode electrodes 3.

In FIG. 4, a process burner 110 uses surplus hydrogen that was not consumed in the stack 100. The process burner 110 heats water, and the heated water is stored in a warm water storage 120. The secondary cooling water, heated by the cooling water that is circulating through the stack 100, can be sent to the water storage 120. However, the temperature of the secondary cooling water is not high enough for a variety of applications. Therefore, a fuel cell system having a structure in which the process burner 110 that uses surplus hydrogen is generally employed, to produce useable hot water.

In order to have a normal electrochemical reaction in the stack 100, the interior of the stack 100 must be maintained at an appropriate temperature. Generally, in the fuel cell system having a phosphoric acid polymer electrolyte membrane, a normal operating temperature of the stack 100 is 120° C. However, it takes time for the stack 100 to reach the operating temperature during a start up operation. During the start up operation, to increase the temperature of the stack 100, a cooling water tank 130 must be heated using a heat source, such as an electric heater (not shown). The temperature of the stack 100 is increased by circulating the heated water.

When a normal electrochemical reaction occurs, the temperature of the stack 100 rises, due to the exothermic electrochemical reaction. During the start up operation, the stack 100 is heated to an appropriate temperature by circulating the heated cooling water. However, when the stack 100 is heated using the heated cooling water, it takes approximately two hours to reach the normal operating temperature of 120° C. Accordingly, although the fuel processor 200 is ready to supply hydrogen to the stack 100, the fuel processor 200 must wait until the temperature of the stack 100 reaches the normal operating temperature.

The temperature of the stack 100 can be rapidly increased, if the electrochemical reaction is generated while the temperature of the stack 100 is being increased by circulating the heated cooling water. However, in the case of the phosphoric acid polymer electrolyte membrane, if the electrochemical reaction occurs at a low temperature, that is, below 100° C., phosphoric acid contained in the phosphoric acid polymer electrolyte membrane is eluted by water condensing in the stack 100. In the phosphoric acid polymer electrolyte membrane, phosphoric acid acts as a carrier of hydrogen ions, between the anode 1 and the cathode 3, to induce an electrochemical reaction therebetween. If phosphoric acid is eluted, a normal electrochemical reaction does not properly occur, even if the temperature reaches the normal operation temperature.

Accordingly, in order to rapidly increase the temperature of a fuel cell system that uses a phosphoric acid polymer electrolyte membrane, at initial start up of the fuel cell system, there is a need to develop a method that can prevent phosphoric acid from being eluted from the phosphoric acid polymer electrolyte membrane, while using heat generated from an electrochemical reaction of the stack 100.

### SUMMARY OF THE INVENTION

Aspects of the present invention provide a fuel cell system having a phosphoric acid polymer electrolyte membrane. The fuel cell system can prevent phosphoric acid from eluting from the phosphoric acid polymer electrolyte membrane, while directly using heat generated from an electrochemical reaction in a stack, during an initial start up operation The present teachings encompass a method of starting the fuel cell system.

According to an aspect of the present invention, there is provided a fuel cell system comprising: a stack having a phosphoric acid polymer electrolyte membrane, to electrochemically react hydrogen and oxygen; and a water circulating unit that heats cooling water supplied to the stack, and increases the temperature of the stack. The fuel cell system includes an air circulating unit that circulates heated air (as a source of oxygen) to the stack, and a heating unit to heat the air.

According to another aspect of the present invention, there is provided a method of starting a fuel cell system having a phosphoric acid polymer electrolyte membrane, the method comprising: increasing the temperature of a stack to an appropriate temperature, by passing heated cooling water through the stack at an initial start up; and increasing the temperature of the stack, by generating an electrochemical reaction, while maintaining a condition that inhibits the elution of phosphoric acid from the stack, due to water condensation.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a schematic drawing illustrating the energy transformation structure of a conventional fuel cell;

FIG. 2 is a perspective view of a conventional unit cell structure of a fuel cell;

FIG. 3 is an exploded perspective view of a conventional fuel cell stack;

FIG. 4 is a block diagram of a conventional fuel cell system having a phosphoric acid polymer electrolyte membrane;

FIG. 5 is a block diagram of a fuel cell system having a phosphoric acid polymer electrolyte membrane, according to an exemplary embodiment of the present invention;

FIG. 6 is a graph showing the variation of relative humidity in a stack, according to air temperature and oxygen utilization;

FIGS. 7A and 7B are flow charts showing start up operations of the fuel cell system of FIG. 5, according to an exemplary embodiment of the present invention;

FIG. 8 is a graph showing the temperature increase of a stack during start up, using the processes of FIGS. 7A and 7B;

FIGS. 9 and 10 are block diagrams showing modified fuel cell systems having a phosphoric acid polymer electrolyte membrane, from the fuel cell system of FIG. 5; and

FIG. 11 is a flow chart showing a start up of a fuel cell system having a phosphoric acid polymer electrolyte membrane, according to another exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

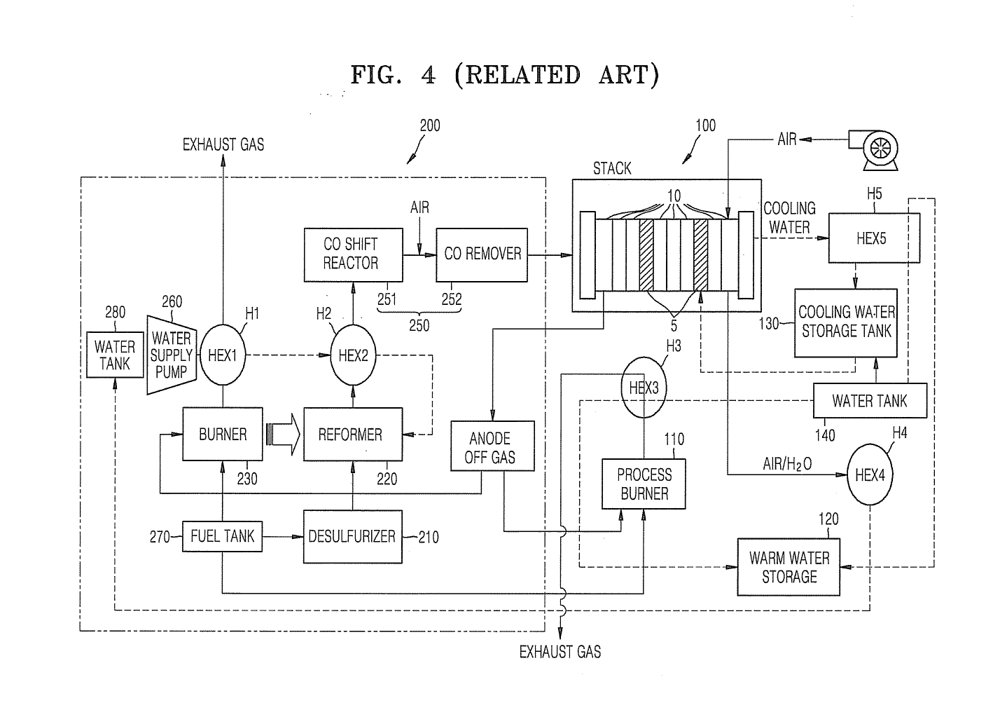

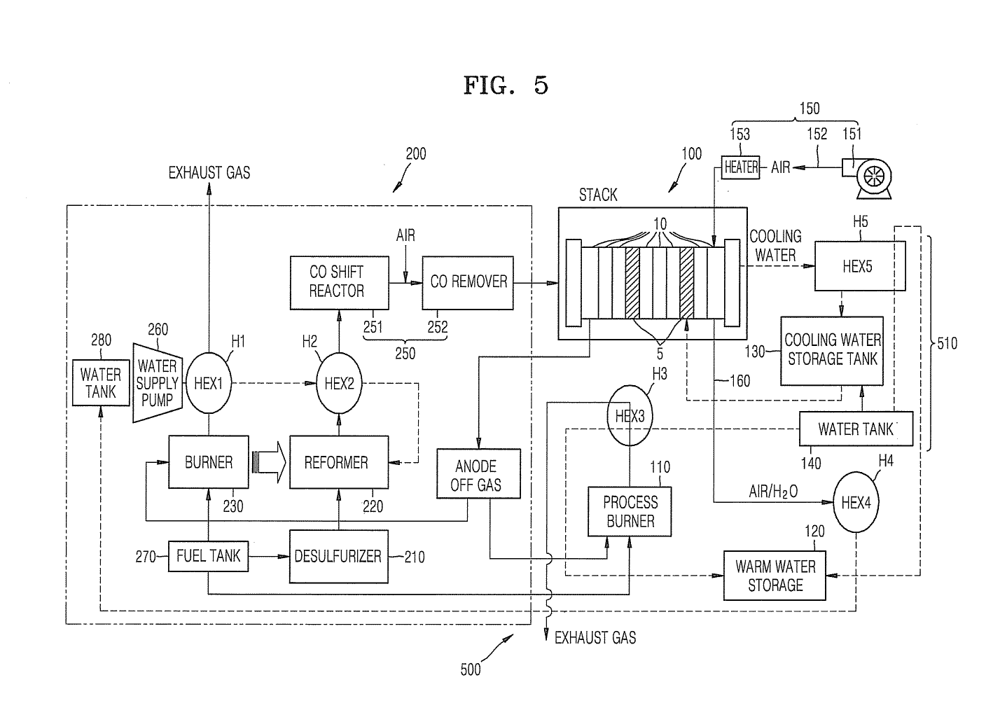

FIG. 5 is a block diagram of a fuel cell system 500 having a phosphoric acid polymer electrolyte membrane, according to an exemplary embodiment of the present invention. The fuel cell system 500 has a fuel processor 200 that generates hydrogen, and supplies the hydrogen to a stack 100. In the stack 100, an electrochemical reaction occurs using the hydrogen supplied from the fuel processor 200. The fuel processor 200 of FIG. 5 has the same elements and connection structure as the conventional fuel processor 200 of FIG. 4, thus, detailed descriptions thereof will not be repeated.

Also, remaining parts, including the stack 100 of the fuel cell system 500, have similar elements and connection structures to the fuel cell system of FIG. 4. Aspects of the present exemplary embodiments relate to modifications of the air supplying structure, so as to rapidly heat the stack 100 at initial start up.

The fuel cell system 500 includes a water circulating unit 510 to heat and/or cool the stack 100. During a normal operation, the water circulating unit 510 cools the stack 100 by supplying cooling water stored in a cooling water storage tank 130, to cooling plates 5 in the stack 100. The cooling water absorbs heat in the stack 100, and then is conveyed to a heat exchanger H5. The heat exchanger H5 cools the cooling water, by exchanging heat with secondary cooling water from a water tank 140. The cooled cooling water returns to the cooling water storage tank 130. At an initial start up, in order to rapidly increase the temperature of the stack 100, the cooling water from the cooling water storage tank 130 is heated using a heating unit, for example an electric heater (not shown). The heated cooling water is circulated to the stack 100.

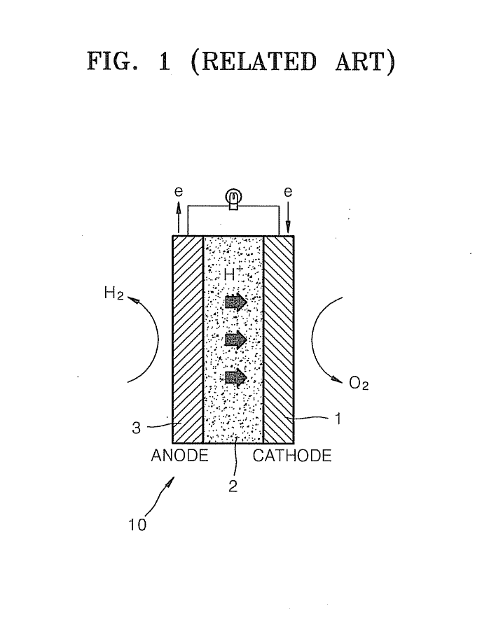

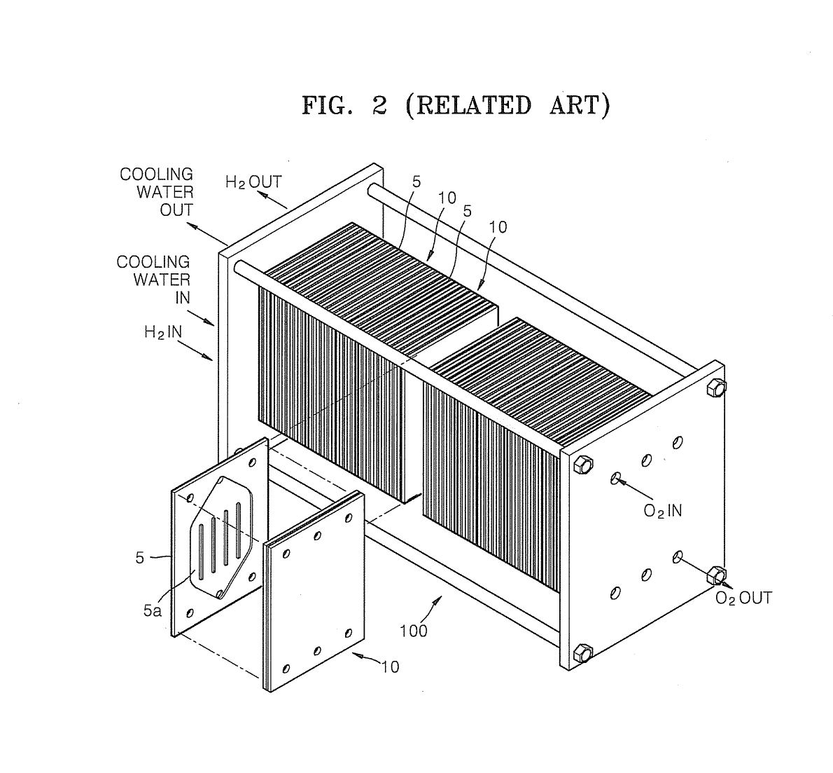

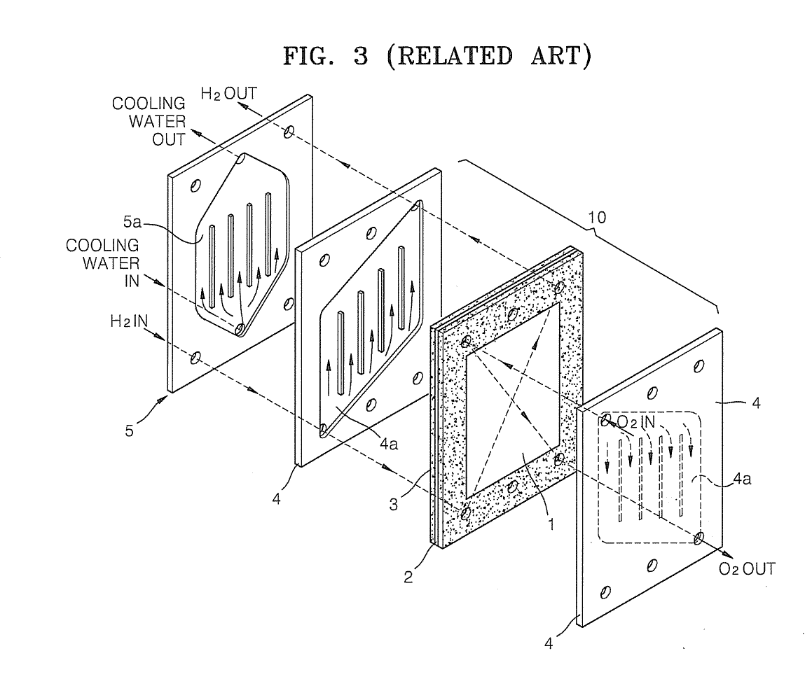

Up to this point, the operation of the fuel cell system of FIG. 5 is similar to the conventional fuel cell system of FIG. 4. However, in the present exemplary embodiment, a heating element, for example a heater 153, is included in an air circulating unit 150, so that heated air can be supplied to the stack 100. The blower 151 supplies heated fresh air (as a source of oxygen) to the stack 100. In this case, a heater 153 is installed on an air inlet line 152, to supply heated air to the stack 100. If the heated air is supplied to the stack 100, the condensation of water vapor in the stack 100 can be avoided. Accordingly, the elution of phosphoric acid from the phosphoric acid polymer electrolyte membrane 2 (refer to FIG. 1) can be prevented, while an electrochemical reaction occurs in the stack 100. After heating the stack 100 to approximately 80° C., using the heated cooling water, the electrochemical reaction is generated while supplying the heated air to the stack 100. The temperature of the stack 100 can be rapidly increased without eluting the phosphoric acid from the phosphoric acid polymer electrolyte membrane 2.

If the heated air is supplied, the saturated vapor pressure is increased in the stack 100, and thus, vapor does not substantially condense in the stack 100. The relative humidity φ in the stack 100 is expressed as PW/Psat, where Pw is the partial vapor pressure of water in the stack 100 and Psat is the saturated vapor pressure of water in the stack 100. If the relative humidity φ is greater than 1, that is, if PW>Psat, condensation is promoted in the stack 100. Thus, in order to limit condensation, the partial vapor pressure PW is reduced, or the saturated vapor pressure Psat is increased. In the present exemplary embodiment, the saturated vapor pressure Psat is increased by supplying heated air. Equation 1 relates to the relative humidity φ, expressed as a function of the temperature of the air entering into the stack 100, internal temperature of the stack 100, and the relative humidity of the entering air.

$$Φ = \frac{( 2 - \frac{( φ + 2 )}{( 1 + φ ) + 0.210 \times U} ) \times {P}_{ext}}{{10}^{- 2.1794 + 0.02953 T - 9.1837 \times {10}^{- 5} {T}^{2} + 1.4454 \times {10}^{- 7} {T}^{3}} / 100} \qquad [ Equaiton 1 ]$$

T: (entering air temperature+cell operation temperature in the stack)/2

Pₑₓₜ: pressure at stack outlet

ψ: relative humidity of entering air

U: oxygen utilization factor

As it can be seen from Equation 1, when the oxygen utilization factor is reduced, by increasing the temperature of entering air, or by increasing the pressure of the supplied air, the relative humidity φ is reduced. Thus, condensation can be limited. Without referring to the Equation 1, when the temperature in the stack 100 is increased, the saturated vapor pressure in the stack 100 is increased, thus, the vapor condensation can be limited. When the air is supplied at a higher pressure, the partial vapor pressure is reduced, thus, the condensation of vapor can be limited.

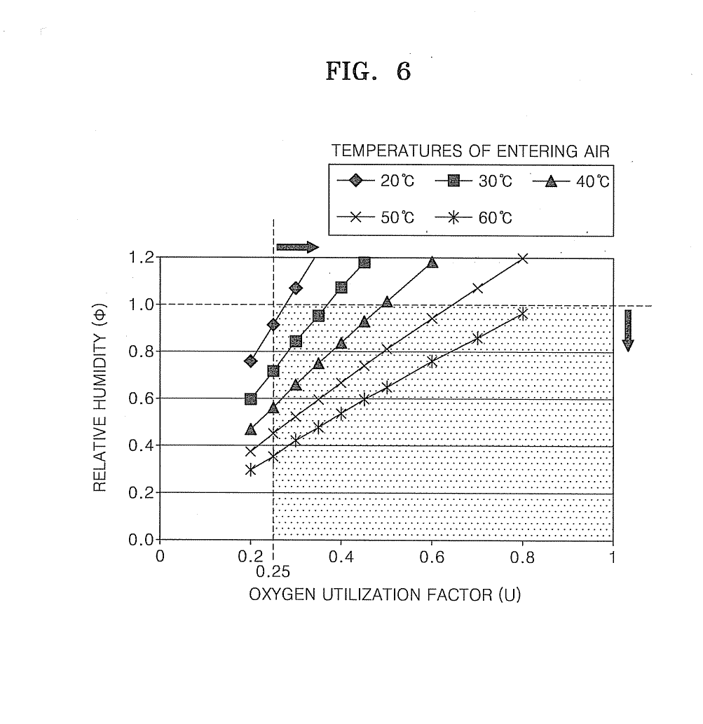

FIG. 6 is a graph showing a simulation result correlating the relative humidity and an oxygen utilization factor of the stack, and the temperature of entering air. The fuel cell system used for the simulation was operated at 50% of a normal load. It was assumed that the relative humidity of the entering air was 0.6, and the operation temperature of the stack was 80° C. As it can be seen from the graph, as the temperature of the entering air was increased, the cases that the relative humidity of the stack is greater than 1, which is a condensation limit, was reduced. As the oxygen utilization factor was reduced, that is, as the volume of supplied air (air pressure) was increased, the relative humidity was reduced. However, when a load to the blower was too high, the oxygen utilization factor was reduced to below 0.25 (25%). The oxygen utilization factor is generally maintained at greater than 25%. If the relative humidity is maintained in a dotted region in FIG. 6, the condensation of vapor can be limited.

Aspects of the present exemplary embodiment employ the method of increasing the temperature of entering air, to increase saturated vapor pressure in the stack 100. A method of preventing condensation of vapor, by increasing the volume of supplying air will be described later. Two exemplary methods of starting the fuel cell system (start up), having the above configuration, will now be described.

In a first exemplary method, the temperature of the stack 100 is increased to approximately 80° C. (below 100° C.), using heated cooling water. The temperature of the stack 100 is then increased using heat generated from an electrochemical reaction in the stack 100, while supplying heated air to the stack. In another exemplary method, the temperature of the stack 100 is increased by circulating the heated cooling water while generating the electrochemical reaction in the stack 100.

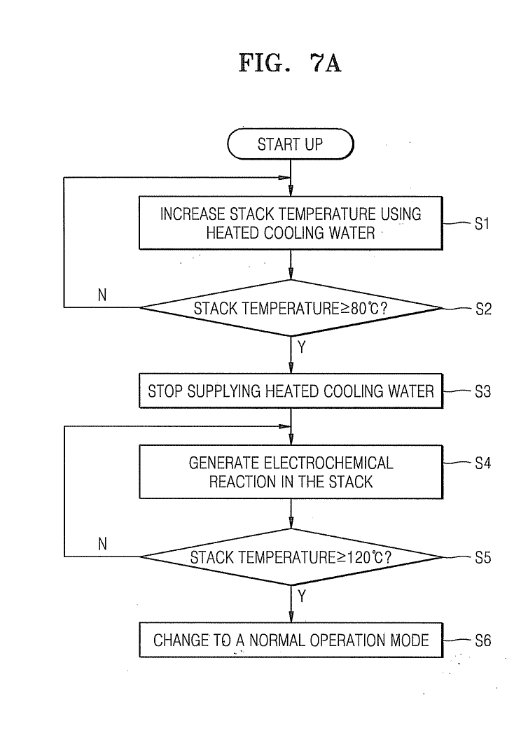

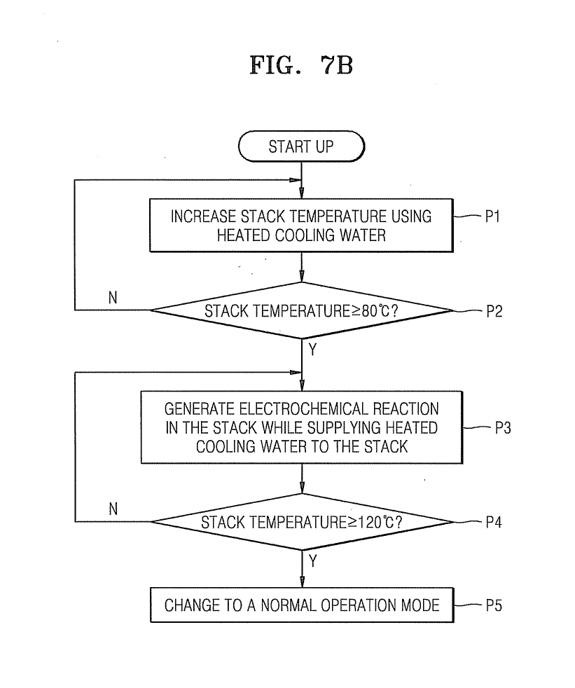

In the first exemplary method, the fuel cell system is started according to the flow chart of FIG. 7A. At the beginning of start up, cooling water in the cooling water storage tank 130 is heated using an electric heater. The stack 100 is heated by passing the heated cooling water through the stack 100 (S1). When the temperature of the stack 100 reaches an appropriate temperature (S2), for example, 80° C. (below 100° C.), the supply of heated cooling water to the stack 100 is stopped (S3). Next, an electrochemical reaction is generated by simultaneously supplying air heated by the heater 153, to the cathode of the stack 100, and hydrogen supplied from the fuel processor 200, to the anode of the stack 100 (S4). When the temperature of the stack 100 reaches an appropriate temperature, the temperature of the stack 100 is increased, due to heat generated from the electrochemical reaction in the stack 100. Afterwards, when the temperature of the stack 100 reaches an appropriate operating temperature (about 120° C.) (S5), the fuel cell system switches to a normal operation mode (S6).

In the second exemplary method, the fuel cell system is started according to a flow chart of FIG. 7B. The stack 100 is heated to about 80° C., using the heated cooling water. Then, while continuing to provide the heating cooling water, heat is generated from an electrochemical reaction (P1). When the temperature of the stack 100 reaches an appropriate temperature (P2), for example, 80° C., while maintaining the supply of heated cooling water to the stack 100, an electrochemical reaction is generated in the stack 100, by simultaneously supplying the air heated by the heater 153, to the cathode 3 of the stack 100, and hydrogen supplied from the fuel processor 200, to the anode 1 of the stack 100 (P3). At this point, the temperature of the stack 100 is increased by both the heated cooling water and the heat generated from the electrochemical reaction. When the temperature of the stack 100 reaches an appropriate operating temperature, (120° C.) (P4), the fuel cell system 500 is switched to a normal operation mode (P5).

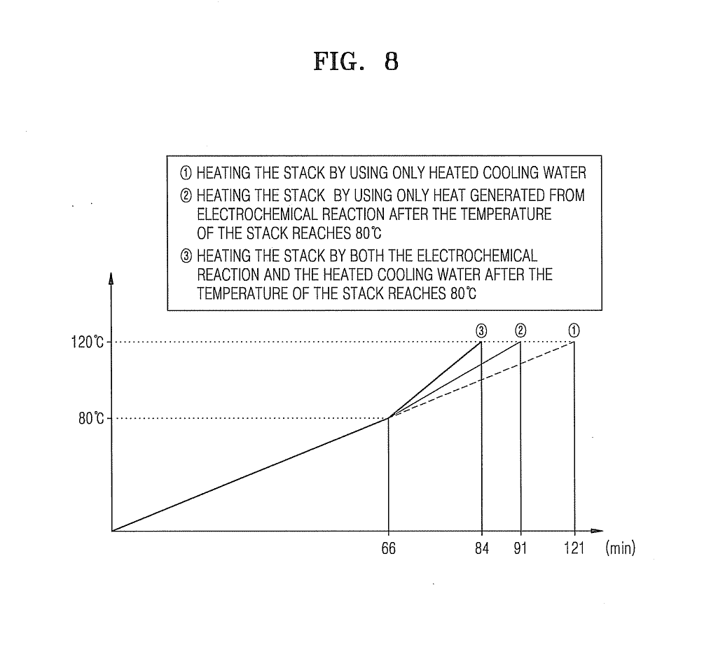

FIG. 8 is a graph showing times required to reach the normal operating temperature (120° C.), when the stack 100 is operated using the methods described above. When the stack 100 is heated conventionally (only using the heated cooling water), it takes approximately 2 hours to reach a normal operating temperature. However, when the exemplary methods are employed; the starting time can be reduced by 30 to 40 minutes, as compared to the conventional heating method. Therefore, a normal operation of the fuel cell system can be achieved within a shorter time.

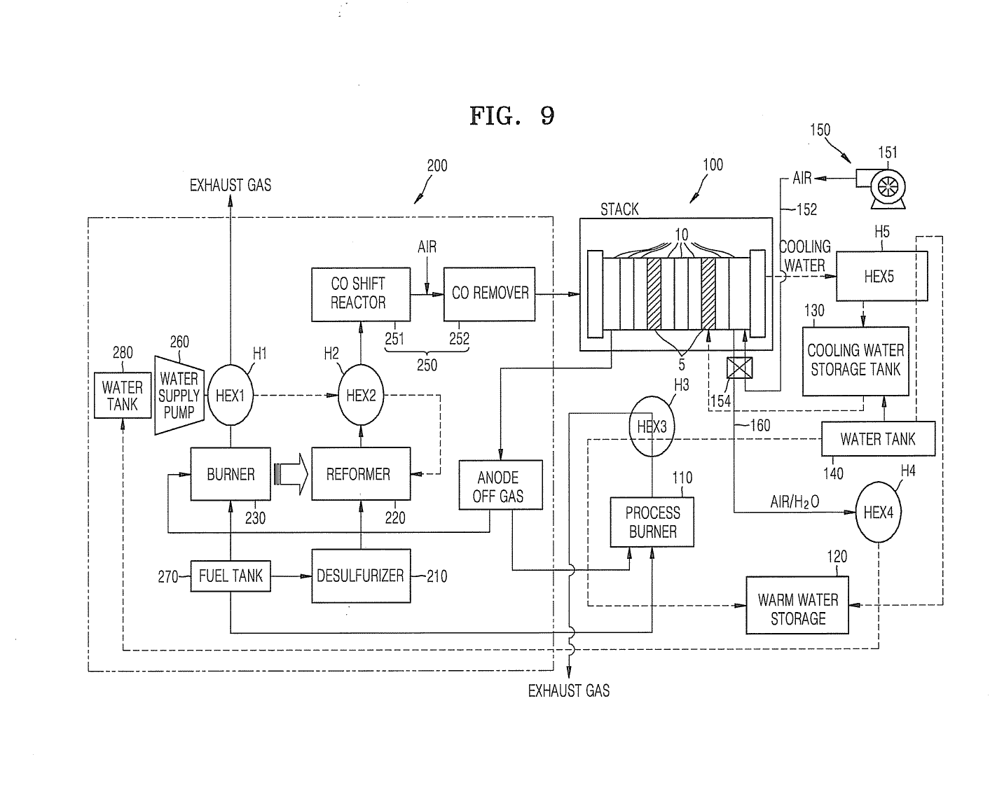

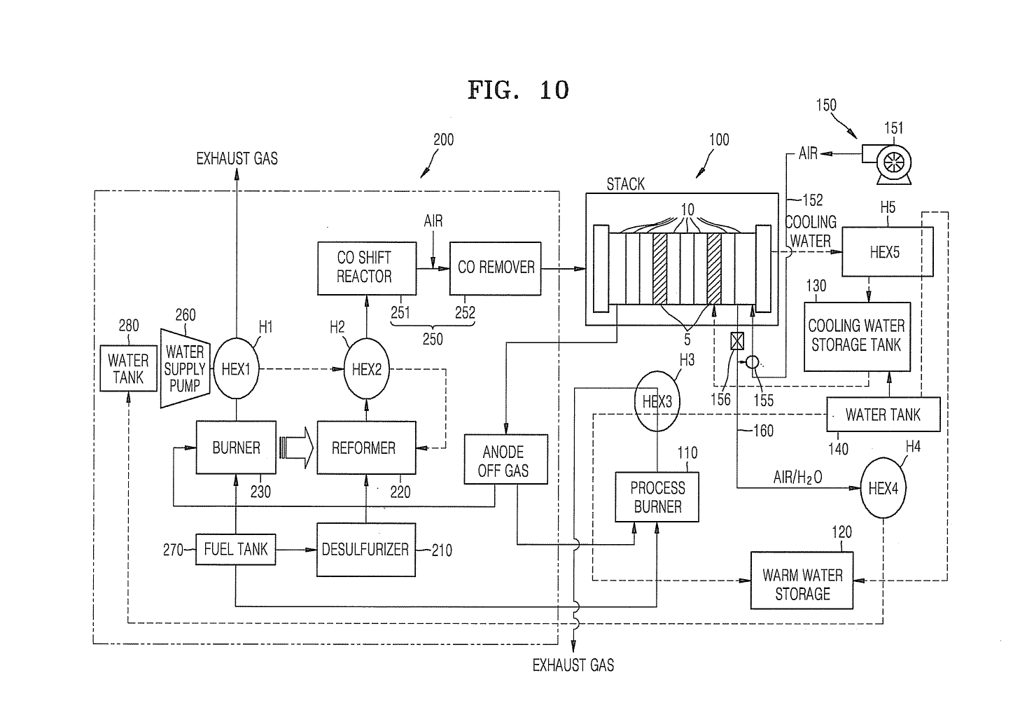

Referring to FIG. 5, the heater 153 is installed on the air inlet line 152, to heat (fresh) air supplied to the stack 100. However, other configurations of the air circulating unit 150, as shown in FIGS. 9 and 10, can also be employed. In FIG. 9, the air circulating unit 150 includes a heat exchanger 154. The heat exchanger is disposed in the air inlet line 152, and uses air exhausted from the stack 100, through an exhaust line 160, to heat the (fresh) air.

In FIG. 10, the air circulating unit 150 includes an ejector 155 installed on the air inlet line 152, and a moisture remover 156. A portion of the hot air exhausted through the air exhaust line 160 is injected into the air inlet line 152. Moisture in the exhausted air is removed by the moisture remover 156, which is disposed on the air exhaust line 160. Then the dried exhausted air is mixed with the fresh air to heat the fresh air. In this case, the prevention of condensation of vapor is improved, since the heated dry air re-enters the stack 100.

In the exemplary embodiments of FIGS. 9 and 10, the methods of FIGS. 7A and 7B can be employed. That is, the operation of the stack 100 starts when the temperature reaches 80° C. From this point, a further increase in the temperature of the stack 100 can be performed by heat exchanging with the exhaust gas as depicted in FIG. 9, or by using a portion of exhaust gas as depicted in FIG. 10.

So far, in order to limit the condensation of vapor in the stack 100, methods of increasing the temperature in the stack 100, to increase in saturated vapor pressure, have been described. However, the stack 100 can be operated such that the partial vapor pressure is smaller than the saturated vapor pressure, by increasing the volume (pressure) of supplied air.

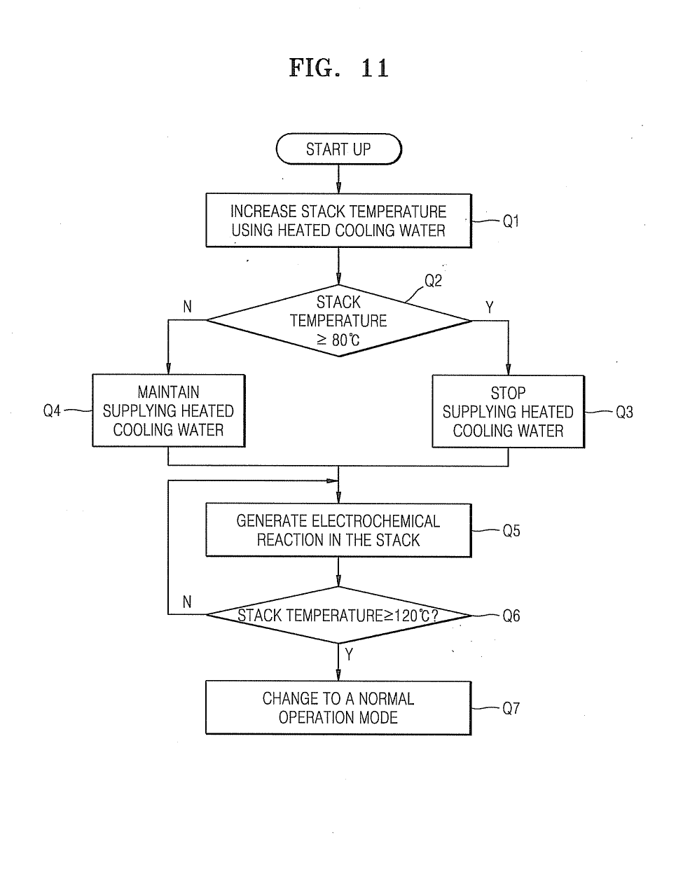

FIG. 11 is a flow chart showing a start up method of a fuel cell system having a phosphoric acid polymer electrolyte membrane, according to another exemplary embodiment of the present invention. Referring to FIG. 11, the stack 100 is heated using heated cooling water (Q1). If the temperature of the stack 100 reaches 80° C. (Q2), an electrochemical reaction is generated by supplying air and hydrogen to the stack 100 (Q5). At this point, the volume (pressure) of air supplied to the stack 100 is increased, by operating the blower 151, such that the relative humidity is within the dotted region of FIG. 6. In this case, an electrochemical reaction occurs in the stack 100, in a state that condensation of vapor is depressed, and thus, the temperature of the stack 100 can rapidly reach a normal operation temperature. Also, when the temperature of the stack 100 reaches an appropriate temperature, the supply of heated cooling water to the stack 100 can be stopped (Q3). Alternatively, the temperature of the stack 100 can be increased using only the heat generated from the electrochemical reaction in the stack 100, or by using the heat generated from the electrochemical reaction in the stack 100, and the heated cooling water (Q4). When the temperature of the stack 100 reaches 120° C. (Q6), the fuel cell system is converted to a normal operation mode (Q7).

Thus, the temperature of the stack 100 can be rapidly increased, while limiting the condensation of water vapor in the stack 100, thereby preventing phosphoric acid from being eluted from the phosphoric acid polymer electrolyte membrane.

As described above, a fuel cell system having a phosphoric acid polymer electrolyte membrane has the following advantages. First, when a rapid temperature increase in a stack is required, such as at an initial start up, the temperature of the stack can be increased by not only using heated cooling water, but also heat generated from an electrochemical reaction, thereby greatly reducing time required for the fuel cell system to reach a normal operating temperature. Second, the substantial condensation of water vapor in the stack is prevented. Thus, the elusion of phosphoric acid from the phosphoric acid polymer electrolyte membrane is prevented, thereby securing a stable electrochemical performance of the fuel cell system. Third, the heating element to heat entering air can be modified, or the capacity of a blower can be modified. Thus, the modification from a conventional fuel cell system is easy, and can be performed at a low cost.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A fuel cell system, comprising:
a phosphoric acid polymer electrolyte membrane fuel cell stack, to produce an electrochemical reaction using hydrogen and oxygen;
a water circulating unit to supply heated cooling water to the stack to increase a temperature of the stack; and
an air circulating unit to heat air, and to circulate the heated air to the stack as a source of the oxygen, such that phosphoric acid is not eluted from the membrane due to condensation of water in the stack.

2. The fuel cell system of claim 1, wherein the air circulating unit comprises a heater to heat the air.

3. The fuel cell system of claim 1, wherein the air circulating unit comprises a heat exchanger to heat the air using exhaust gas from the stack.

4. The fuel cell system of claim 1, wherein the air circulating unit comprises an injector to inject exhaust gas from the stack into the circulating unit in order to heat the air in the circulating unit.

5. The fuel cell system of claim 4, wherein the air circulating unit comprises a moisture remover to remove moisture from the exhaust gas before the exhaust gas is injected into the air circulating unit.

6. A method of starting a fuel cell system comprising a fuel cell stack comprising a phosphoric acid polymer electrolyte membrane, the method comprising:
circulating heated cooling water through the stack to increase the temperature of the stack to a first temperature; and
generating an electrochemical reaction in the stack to increase the temperature of the stack to an operating temperature, by supplying hydrogen and air to the stack, such that phosphoric acid is not eluted from the membrane by water vapor condensation in the stack.

7. The method of claim 6, wherein the circulating of the heated cooling water is stopped before the generating of the electrochemical reaction.

8. The method of claim 6, wherein, the circulating of the heated cooling water and the generating of the electrochemical reaction are simultaneously performed once the temperature of the stack reaches the first temperature.

9. The method of claim 6, wherein the first temperature is less than 100° C.

10. The method of claim 6, wherein the generating of the electrochemical reaction comprises heating the air supplied to the stack.

11. The method of claim 6, wherein the generating of the electrochemical reaction comprises controlling the volume of the air supplied to the stack such that a partial vapor pressure of the water vapor does not reach a saturation point of the water vapor.

12. The method of claim 10, wherein the air is heated such that the relative humidity of the air is less than 100% and an oxygen utilization factor of the stack is greater than 25%.

13. The method of claim 10, wherein the air is heated using exhaust gas from the stack.

14. The method of claim 6, further comprising switching the stack to a normal operation once the stack has reached the operating temperature.

15. The method of claim 6, wherein the generating of the electrochemical reaction comprises pressurizing the air, such that the relative humidity of the air is less than 100%.

16. The method of claim 6, wherein the operating temperature is about 120° C.

17. The method of claim 6, wherein the first temperature is between 80° C. and 100° C.

18. The fuel cell system of claim 1, wherein the air circulating system comprises a blower to circulate the air.

19. The fuel cell system of claim 18, wherein the blower pressurizes the air such that the relative humidity of the air is less than 100%.

20. A method of starting a fuel cell system comprising a fuel cell stack comprising a phosphoric acid polymer electrolyte membrane, the method comprising:
circulating heated cooling water through the stack to increase the temperature of the stack to a first temperature; and
generating an electrochemical reaction in the stack to increase the temperature of the stack to an operating temperature, by supplying hydrogen and air to the stack, such that phosphoric acid is not eluted from the membrane by water vapor condensation in the stack,
wherein the air is pressurized such that the relative humidity of the air is less than 100%.

21. The method of claim 12, wherein the generating of the electrochemical reaction comprises heating the air.
